(19) United States
(12) Patent Application Publication
(10) Pub. No.: US 2026/0035879 A1
(43) Pub. Date: Feb. 5, 2026

(54) BUCKET GRABBER

(71) Applicant: CMP Attachments, LLC, Clear Lake, MN (US)

(72) Inventors: Derek KENT, Becker, MN (US); David PHANEUF, Saint Cloud, MN (US)

(73) Assignee: CMP Attachments, LLC, Clear Lake, MN (US)

(21) Appl. No.: 19/289,957

(22) Filed: Aug. 4, 2025

Related U.S. Application Data
(60) Provisional application No. 63/678,655, filed on Aug. 2, 2024.

(51) Int. Cl. E02F 3/96; B66C 3/20

(52) U.S. Cl. CPC E02F 3/963; B66C 3/20

(57) ABSTRACT

A grapple assembly includes a grapple with two opposing arms connected to a boom arm of an excavator for engaging an attachment plate connected to an excavator attachment, such as a bucket. The attachment plate includes two outwardly extending plates creating two receivers for engaging the grapple arms. The attachment plate allows an operator of the excavator to use the grapple to handle large items, and to use the grapple to grab the attachment plate connected to a bucket to use the bucket to handle small items without having to disconnect the grapple from the boom arm and attach the bucket to the boom arm.

### CROSS-REFERENCE TO RELATED APPLICATIONS

This application claims priority in U.S. Provisional Patent Application Ser. No. 63/678,655, filed Aug. 2, 2024, the contents of which are hereby incorporated by reference.

### BACKGROUND

### 1. Field of the Disclosed Subject Matter

A bucket arrangement for use with grapple machinery.

### 2. Background

Grapple equipment is a type of attachment for a motorized vehicle such as a backhoe or an excavator, and is used to grasp and move objects or material. Grapple equipment is commonly designed as two pivotal opposing fork arms, which works well for grasping objects, but not particulate material.

Many of the motorized vehicles that can be equipped with grapple equipment can alternatively be equipped with other types of tools or attachments, including a bucket. However, it takes a significant effort to swap out one attachment for another.

There is a need to use a grapple with other attachments that can supplement the functionality of a grapple to better handle particulate material and reduce the time it takes to convert from one type of attachment to another.

### SUMMARY

An implementation of the disclosed subject matter includes a grapple assembly connected to a boom arm of an excavator, with the grapple assembly having opposing first and second arms. The arms engage receivers formed by an attachment plate. The attachment plate is connected to an attachment, such as an excavator bucket, and the grapple can grab the bucket using the attachment plate allowing a user of the excavator to use the grapple assembly to pick up large items and use the bucket to pick up smaller items, without detaching the grapple assembly from the boom arm and then attaching the bucket to the boom arm.

### BRIEF DESCRIPTION OF THE DRAWINGS

The present disclosed subject matter is described herein with reference to the following drawing figures, with greater emphasis being placed on clarity rather than scale:

FIG. 1 is an isometric view of a grapple assembly of the disclosed subject matter attached to a motorized vehicle.

FIG. 2 is an exploded view of the grapple assembly.

FIG. 3 is an isometric view of the grapple assembly.

FIG. 4 is a front elevation sectional view of the grapple assembly generally along line 4-4 in FIG. 3.

FIG. 5 is an enlarged view of FIG. 4 generally within circle 5-5 in FIG. 4.

### DETAILED DESCRIPTION

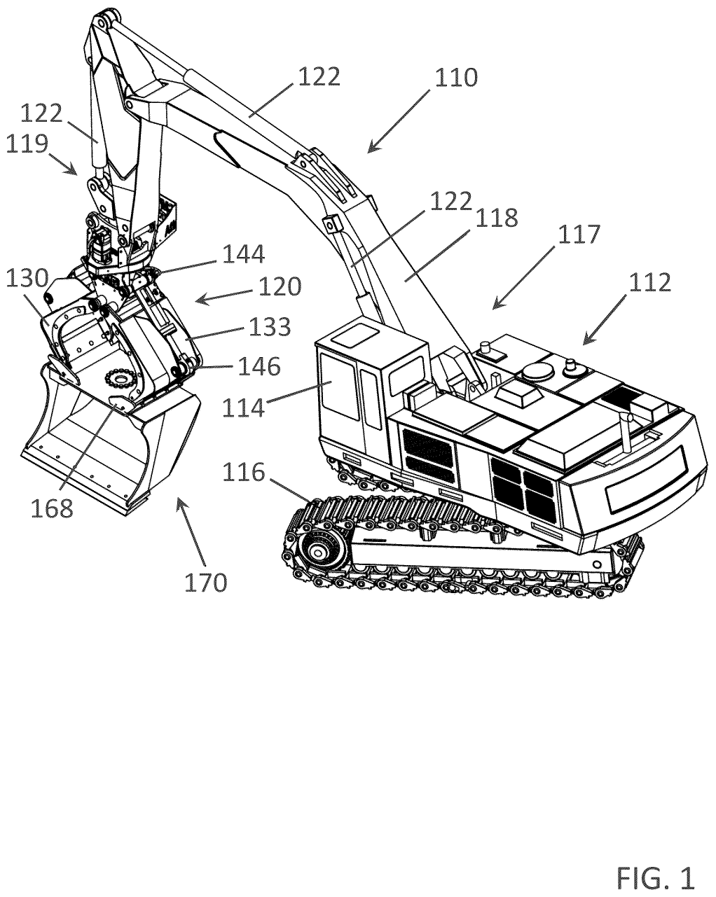

Referring to FIG. 1, a grapple assembly is shown and described, whereby an engagement assembly, such as a grapple 120 is releasably connected to an attachment device, such as a bucket 170, by a receiver assembly, such as an attachment plate 160.

FIG. 1 illustrates one of many possible types of motorized vehicles used with a grapple 120 and attachments. In an implementation, a vehicle 110, has a body that includes an engine area 112 and cab 114. The body of the vehicle is mounted on tracks 116 for movement. A boom arm 118 is pivotally mounted at a first end 117 to the body of the vehicle. At a second end 119 of the boom arm is attached a grapple assembly with the hydraulicly-actuated grapple 120. The vehicle 110 further includes means for powering the boom for movement up and down and side to side and means for delivering power to the grapple 120 attached to the second end 119 of the boom arm 118. A hydraulic pump (not shown) is fluidly connected to hydraulic cylinders 122, and is the typical means for delivering power to the boom arm and grapple assembly, but other power systems known in the prior art may be utilized. In an implementation, the vehicle 110 may be a backhoe or an excavator.

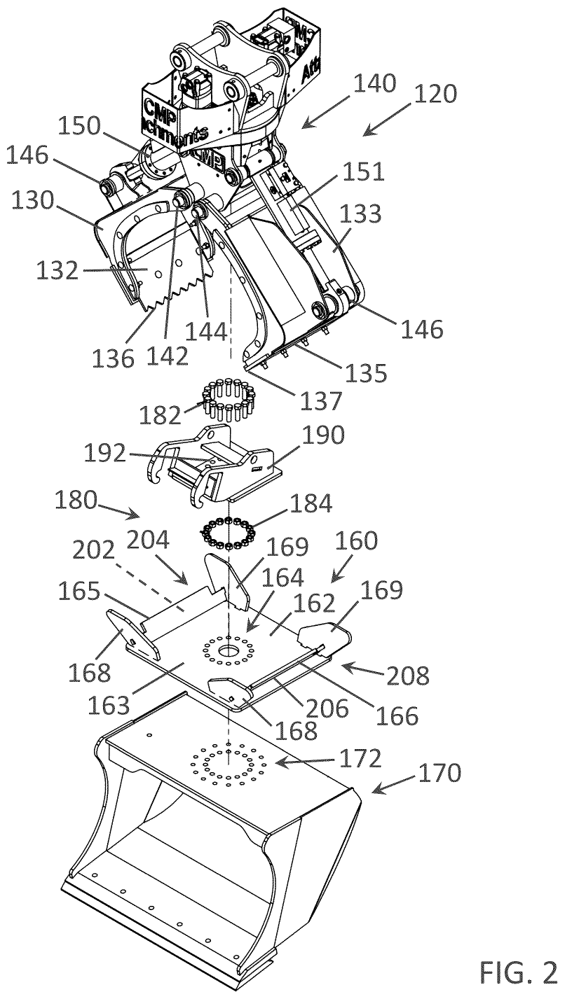

Referring to FIG. 2, a typical grapple 120 includes two opposing, pivotally mounted arms 130 and 133 pivotally attached at pivot points 142, 144, respectively, of a grapple frame 140. In an implementation, the arms 130, 133 include side plates 132, 135 rather than forks or prongs. Leading edges 136, 137, respectively, of the plates 132, 135 may be serrated to assist in grasping objects. Because the grapple 120 has pivotally mounted arms 130 and 133, the grapple 120 is useful for grasping objects, but not particulate.

Attached to each arm 130, 133 is a corresponding first and second hydraulic cylinders 150, 151, respectively. A first end of the hydraulic cylinders 150, 151 are pivotally attached to the frame 140. A second end of the hydraulic cylinders 150, 151 are pivotally attached to an outer edge 146 of an arm (such as on arm 133 as shown). Actuation of the hydraulic cylinders move the arms 130 and 133 towards or away from each other upon extension or retraction of the cylinder for grasping objects.

In an implementation, the attachment plate 160 adapted for securing to a bucket 170 by means of fasteners 180 comprising bolts 182 and nuts 184 (although other fastening means known in the art, such as welding may be used). The attachment plate 160 is formed by a base portion or base plate 162 with a first engagement portion or first plate 165 spaced opposite a second engagement portion or second plate 166 located around a central portion. In an implementation, the base plate 162 forms an upper surface 163 whereby the plates 165, 166 are secured thereto, such as by welding. Plate 165 forms an outer or first face 202, and it extends from the base plate 162 at an acute angle outward and away from the central portion, as measured between the first face 202 and the upper surface 163, forming a first receiver 204 adapted to engage the arm 130. Plate 166 forms an outer or first face 206, and the plate 166 extends from the base plate 162 at an acute angle outward and away from the central portion, as measured between the first face 206 and the upper surface 163, forming a second receiver 208 adapted to engage the arm 133. The receivers 204, 208 provide an interface for the grapple 120 to securely engage the attachment plate 160 and to secure the bucket 170 to the boom arm 118 during use of the bucket 170.

The ends of the engagement plates 165, 166 include supports for adding additional stability to the receivers 204, 208. Engagement plate 165 includes a first side plate support 168 at a first end and a second side plate support 169 at an opposite second end, and engagement plate 166 includes a side plate support 168 at a first end and a side plate support 169 at an opposite second end. The side plates 168, 169 may be secured to the base plate 162 and engagement plates 165, 166 by welding. The side plates 168, 169 help hold the engagement plates 165, 166 in proper alignment to receive the leading edges 136, 137 of the grapple 120 arms. The side plates 168, 169 further act to limit or prevent side movement of the grapple 120 when the leading edges 136, 137 are moved into engagement and engaged with the receivers 204, 208, securing each of the grapple 120 arms in place on a corresponding side of the attachment plate 160 between the corresponding side plate supports. In an implementation, the side plates 168, 169 extend outward from the base plate 162 forming an obtuse angle between the side plate inner surface and the base plate 162, thereby guiding the arms 130, 133 into engagement with the respective first and second engagement portions.

The base plate 162 includes a pattern of holes or openings 164, which provide a means for fastening the attachment plate 160 to the top of bucket 170 using bolts 182 and nuts 184. The pattern of openings 164 illustrated in the figures through which fasteners extend is simply one representation of many possible hole patterns.

The bucket 170 can be of a type known in the art, but the top of the bucket is modified to include a pattern of openings 172 for receiving the fasteners 180. The pattern of openings 172 on the top of the bucket 170 aligns with the pattern of openings 164 in the attachment plate 160.

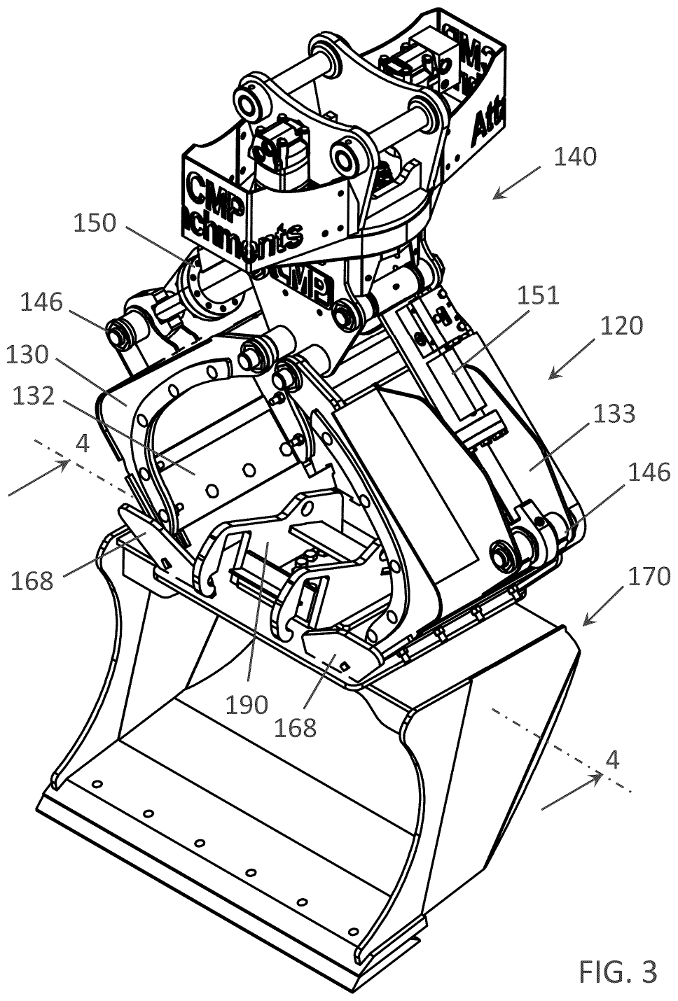

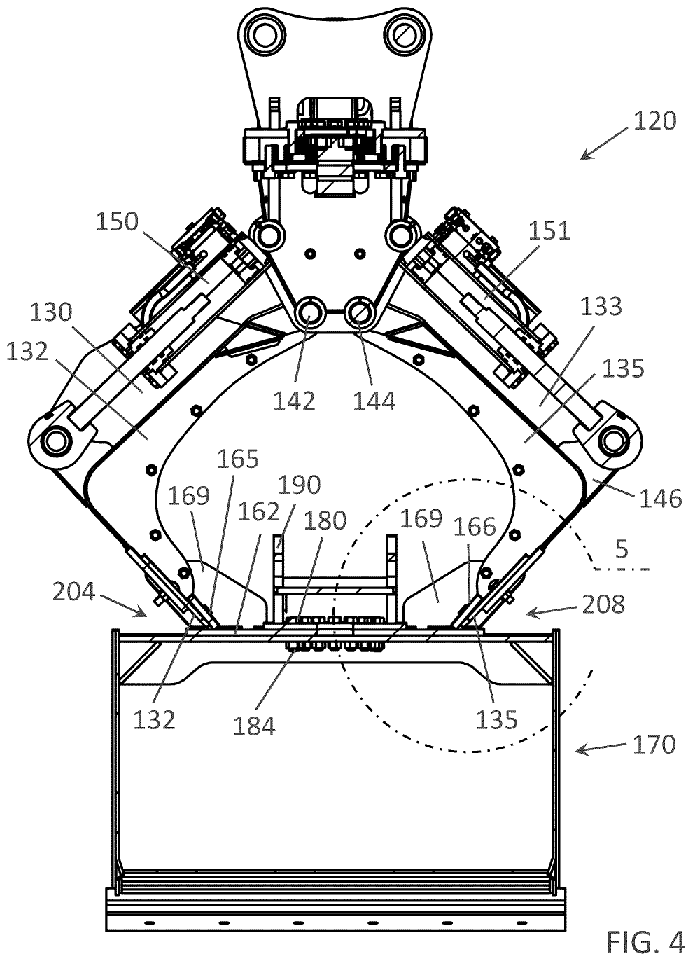

FIGS. 3-4 illustrate how the grapple 120 grasps the attachment plate 160, with each jaw or arm 130, 133 grasping an engagement plate between corresponding side support plates. In this fashion, the bucket 170 may be grasped or released by the grapple 120 in seconds, without the operator of the boom arm 118 ever leaving the cab 114, allowing ready conversion of use of the vehicle 110 from a grapple 120 arrangement to a bucket 170 arrangement. The bucket 170 can be similarly released from the grapple 120 to convert the vehicle 110 back to a pure grapple 120 arrangement. Use of the attachment plate 160 with an attachment avoids the delays caused by prior art systems that typically require one attachment to be physically detached from the boom arm 118 and a second attachment to be physically attached to the boom arm 118 by the boom operator.

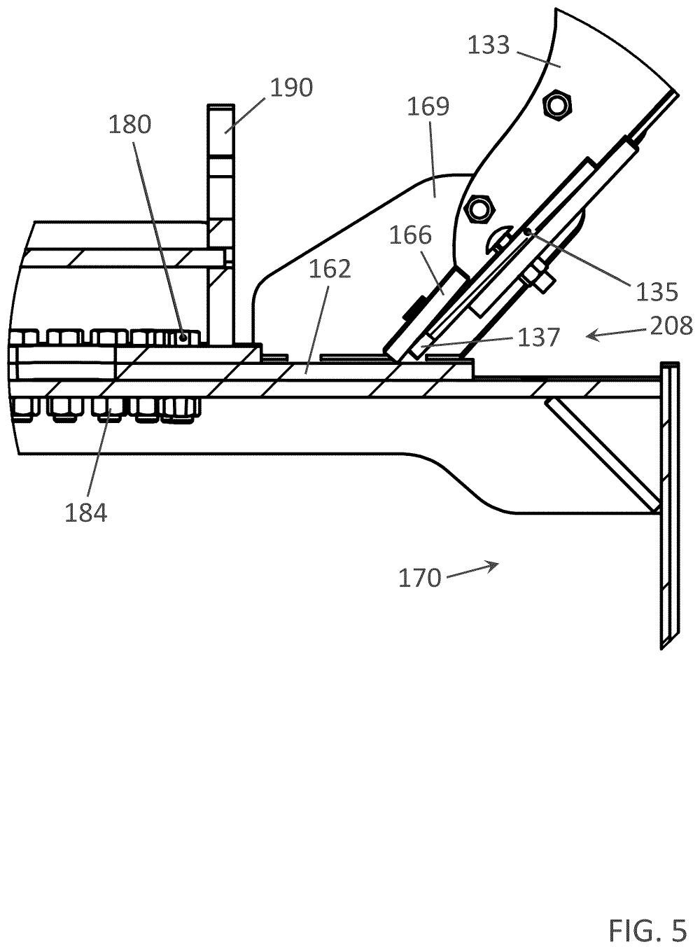

FIG. 5 is a partial, side view of a cutaway of the grapple 120 engaging the attachment plate 160. It illustrates how the leading edge 137 of the grapple 120 arm 130 engages the engagement plate 166. Support 168 is shown abutting a far edge of the leading edge of the grapple arm.

In an embodiment of the disclosed subject matter, a machine specific bracket with mounting ears (190 in FIG. 2) can be secured on top of the attachment plate 160 by a bottom plate 192 forming a pattern of holes or openings in the same arrangement as the openings 164 in the base plate 162, and using the same fasteners 180 and used in conjunction with the bucket 170 and attachment plate 160. Use of ears 190 in conjunction with the attachment plate 160 make it possible for the bucket 170 to be utilized as an attachment with other equipment that mates with the ears 190 without the need to remove the attachment plate 160 from the bucket 170 after use with the grapple 120 as the ears 190 are between the engagement plates 165, 166 and within the opening left by the grapple 120, providing further flexibility for the use of the disclosed subject matter.

Having described the disclosed subject matter, what is claimed as new and desired to be secured by Letters Patent is:

1. An apparatus, comprising:
a grapple assembly, comprising:
a first arm; and
a second arm;
an attachment; and
an attachment plate, comprising:
a base portion adapted for connecting to the attachment;
a first engagement component attached to the base portion, and wherein the first engagement portion is adapted to engage the first arm;
a second engagement component attached to the base portion, wherein the second engagement component is opposing the first engagement component, and wherein the second engagement portion is adapted to engage the second arm.

2. The apparatus of claim 1, comprising:
a bracket, comprising:
a bottom plate adapted for connecting to the attachment plate; and
ears adapted for connecting the bracket to a boom arm.

3. The apparatus of claim 1, comprising:
wherein the grapple assembly further comprises:
a frame;
wherein the first arm is pivotally attached to the frame;
wherein the second arm is pivotally attached to the frame; and
wherein the frame is adapted for connecting the grapple assembly to a boom arm; and
wherein the attached is a bucket.

4. The apparatus of claim 3, comprising:
a vehicle for moving the grapple assembly; and
wherein the boom arm is connected to the vehicle.

5. A receiver assembly for use with an attachment device and an engagement assembly, wherein the engagement assembly includes a first arm and a second arm, the receiver assembly comprising:
a base portion with an upper surface forming a first receiver and a second receiver, and a central portion between the first receiver and the second receiver;
wherein the first receiver is adapted to receive the first arm;
wherein the second receiver is adapted to receive the second arm; and
wherein the central portion is adapted for securing the base portion to the attachment device.

6. The receiver assembly of claim 5, comprising:
wherein the first receiver comprises:
a first plate extending from the base portion at an acute angle from the upper surface outward from the central portion forming an outwardly-open receiver;
wherein the second receiver comprises:
a second plate extending from the base portion at an acute angle from the upper surface outward from the central portion forming an outwardly-open receiver.

7. The receiver assembly of claim 6, comprising:
wherein the first receiver further comprises:
wherein the first plate extends from a first end to a second end;
a first side plate support at the first end extending from the base portion; and
a second side plate support at the second end extending from the base portion;
wherein the second receiver further comprises:
wherein the second plate extends from a first end to a second end;
a first side plate support at the first end extending from the base portion; and
a second side plate support at the second end extending from the base portion.

8. The receiver assembly of claim 5, comprising:
wherein the attachment device is a bucket for use with a boom arm.

9. The receiver assembly of claim 5, comprising:
wherein the engagement assembly is a grapple, comprising:
a first hydraulic cylinder attached to the first arm for moving the first arm into engagement with the first receiver; and
a second hydraulic cylinder attached to the second arm for moving the second arm into engagement with the second receiver.

10. The receiver assembly of claim 5, comprising:
a bracket, comprising:
a bottom plate adapted for securing to the base portion; and
ears adapted for connecting the bracket to a boom arm.

11. The receiver assembly of claim 5, comprising:
wherein the attachment device is a bucket for use with a boom arm.

12. A receiver assembly for use with an attachment device and an engagement assembly, wherein the engagement assembly includes a first arm and a second arm, the receiver assembly comprising:
a base portion forming a central portion;
a first engagement component, comprising:
a first plate extending between a first end and a second end;
wherein the first plate extends from the base portion at an acute angle outward with respect to the central portion;
a first side plate support at the first end forming an inner surface, the first side plate support extending outward from the base portion forming an obtuse angle between the inner surface and the base portion; and
a second side plate support at the second end forming an inner surface, the second side plate support extending outward from the base portion forming an obtuse angle between the inner surface and the base portion;
a second engagement component, comprising:
a second plate extending between a first end and a second end;
wherein the second plate extends from the base portion at an acute angle outward with respect to the central portion;
a third side plate support at the first end forming an inner surface, the third side plate support extending outward from the base portion forming an obtuse angle between the inner surface and the base portion; and
a fourth side plate support at the second end forming an inner surface, the fourth side plate support extending outward from the base portion forming an obtuse angle between the inner surface and the base portion; and
wherein the central portion is disposed between the first plate and the second plate.

13. The receiver assembly of claim 12, comprising:
a grapple assembly, comprising:
a frame;
a first arm pivotally attached to the frame for engaging the first engagement component; and
a second arm pivotally attached to the frame for engaging the second engagement component.

14. The receiver assembly of claim 12, comprising:
an attachment adapted for connecting to the base portion.

15. The receiver assembly of claim 14, comprising:
wherein the attachment is a bucket for use with a boom arm.
